(19) United States
(12) Patent Application Publication
(10) Pub. No.: US 2006/0208623 A1
(43) Pub. Date: Sep. 21, 2006

(54) Panel for wide-angle flat cathode ray tubes

(75) Inventor: Ki Bum Park, Daegu-si (KR)

Correspondence Address: BIRCH STEWART KOLASCH & BIRCH, PO BOX 747, FALLS CHURCH, VA, 22040-0747, US

(73) Assignee: LG. PHILIPS DISPLAYS KOREA CO. LTD., Kumi-si (KR)

(21) Appl. No.: 11/346,155

(22) Filed: Feb. 3, 2006

(30) Foreign Application Priority Data
Mar. 14, 2005 (KR) 2005-21135

(51) Int. Cl. H01J 29/86

(52) U.S. Cl. 313/477 R

(57) ABSTRACT

Disclosed herein is a panel for wide-angle flat cathode ray tubes. The panel includes a face part formed at the front part thereof for displaying a picture, a skirt part having a seal edge joined with the funnel, and a blend round part connected between the face part and the skirt part. On the assumption that the compression stress of a center part, which is the center region of the face part, is σ1, and the compression stress of an edge part, which is the edge region of the face part adjacent to the blend round part, is σ2, the panel is constructed such that the following inequality is satisfied: 1.5≦σ2/σ1≦2.33. Consequently, the present invention has the effect of satisfying the safety of the explosion-resistance characteristic and compensating for the reduction of vacuum strength, which is caused when the deflection angle of the cathode ray tube is increased and the panel is flattened.

### BACKGROUND OF THE INVENTION

1. Field of the Invention

The present invention relates to a panel for cathode ray tubes, and, more particularly, to a panel for wide-angle flat cathode ray tubes wherein the compression stress of the panel is appropriately set to compensate for the reduction of vacuum strength, which is caused when the cathode ray tube has an increased deflection angle and is flattened.

2. Description of the Related Art

Generally, a cathode ray tube is an apparatus that converts an electric signal into an electron beam and scans the electron beam on a fluorescent screen to display picture on a panel.

FIG. 1 is a side view, partially cut away, illustrating the structure of a conventional cathode ray tube. As shown in FIG. 1, the conventional cathode ray tube comprises a panel 1 and a funnel 2, which are joined with each other to constitute a tube part 10.

Inside the panel 1 is disposed a shadow mask 3, which is supported by a frame 4 such that the shadow mask 3 is approximately parallel with the panel 1. The frame 4 is fixed to the panel 1 via a spring 5. Inside the funnel 2 is disposed an inner shield 6 for shielding an external geomagnetic field to prevent the path of an electron beam from being curved by the external geomagnetic field.

In the rear part of the funnel 2 is fitted an electron gun 7 for generating an electron beam. At the outside of a neck part of the funnel 2 is mounted a deflection yoke 8 for deflecting an electron beam approximately 110 degrees or less.

In the conventional cathode ray tube with the above-stated construction, an electron beam emitted from the electron gun 7 is deflected above and below and right and left by the deflection yoke 8, and is then transmitted to the panel 1. Specifically, the deflected electron beam passes through-holes of the shadow mask 3, and is then transmitted to a fluorescent screen 9 coated on the inner surface of the panel 1. At this time, the fluorescent screen 9 is illuminated by the energy of the electron beam. Consequently, a picture is reproduced such that users can see the picture reproduced through the panel 1.

Meanwhile, the panel 1 and the funnel 2 are joined to each other by a frit sealing process, the electron gun 7 is fitted into the rear part of the funnel 2 by a subsequent encapsulation process, and a vacuum is formed in the tube part 10 by an extraction process. In this way, the cathode ray tube is manufactured.

When the tube part 10 is in the vacuum state, considerable tensile and compression stresses are applied to the panel 2 and the funnel 2.

Recently, large-sized, flat, wide-angle cathode ray tubes have been developed, one example of which is indicated by reference numeral 10′ in FIG. 2. In this case, the weights of a panel 1′ and a funnel 2′ constituting the cathode ray tube 10′ are increased. In order to reduce the weights of the panel 1′ and the funnel 2′, a compression stress layer is formed on the surface of the panel 1′ by a process to improve physical strength such as increasing the glass strength, and therefore, the explosion-resistance characteristic is improved. For example, the cathode ray tube must pass a missile test conforming to Underwriters Laboratories (UL) rules.

Specifically, sparks must not be generated in the cathode ray tube 10′ at the time of the missile test. However, if the cathode ray tube 10′ does not crack, it is also a serious problem.

For this reason, it is preferable not to form an excessively strong compression stress layer on the surface of the panel 1′. Consequently, as shown in FIG. 3, it is necessary to design the panel 1′ such that appropriate compression stress is distributed to a center part C, an edge part E, and a skirt part S of the panel 1′, whereby the cathode ray tube 10′ cracks as a result of the missile test, and therefore, the vacuum in the cathode ray tube 10′ is destroyed.

The compression stress layer was formed on the surface of the conventional panel 1′ in stress patterns indicated in Table 1 below, and then a missile test was performed on the panel 1′. However, the results of the missile test were not satisfactory.

TABLE 1

| Edge | Center | | Skirt | | | | | | | | | |
|---|---|---|---|---|---|---|---|---|---|---|---|---|
| (σ2) | (σ1) | σ2/σ1 | (σ3) | σ3/σ1 | Satisfaction | 7J | 9J | 10J | 11J | 12J | 13J | 14J |
| 11.5 | 15.5 | 0.74 | 8.4 | 0.54 | OK | 40% | 67% | 25% | 40% | 20% | | |
| | | | | | NG | 60% | 33% | 75% | 60% | 80% | 100% | |
| 9.5 | 12.5 | 0.76 | 7.5 | 0.60 | OK | | | | | | | |
| | | | | | NG | 100% | 100% | 100% | | | | |

Specifically, when the missile test was performed using energy of 7 J to 14 J while the vacuum in the cathode ray tube was destroyed, sparks were not generated, and therefore, the UL rules were satisfied.

In the case that the stress σ2 of the edge part E of the panel 1′ was less than the stress σ1 of the center part C of the panel 1′ and the stress σ3 of the skirt part S of the panel, as indicates in Table 1, the cathode ray tube did not crack when the panel 1′ was struck during the missile test. As a result, the results of the missile test were not satisfactory. Consequently, it can be seen from Table 1 that the results of the missile test are not satisfactory when the compression stress layer of the panel 1 is too strong.

For this reason, it is required to derive an appropriate standard on the compression stress of the panel 1′ such that the wide-angle flat cathode ray tube has a compression stress that satisfies the UL rules.

### SUMMARY OF THE INVENTION

Therefore, the present invention has been made in view of the above problems, and it is an object of the present invention to provide a panel for wide-angle flat cathode ray tube wherein the compression stress of the panel is appropriately set to satisfy the safety of the explosion-resistance characteristic and to compensate for the reduction of vacuum strength, which is caused when the deflection angle of the cathode ray tube is increased and the panel is flattened.

In accordance with the present invention, the above and other objects can be accomplished by the provision of a panel for wide-angle flat cathode ray tubes, comprising: a face part formed at the front part thereof for displaying a picture; a skirt part having a seal edge joined with the funnel; and a blend round part connected between the face part and the skirt part, wherein, on the assumption that the compression stress of a center part, which is the center region of the face part, is σ1, and the compression stress of an edge part, which is the edge region of the face part adjacent to the blend round part, is σ2, the panel is constructed such that the following inequality is satisfied: 1.5≦σ2/σ1≦2.33.

Preferably, the compression stress of the center part is set such that the following inequality is satisfied: 1.6 MPa≦σ1≦3 MPa.

Preferably, the compression stress of the edge part is set such that the following inequality is satisfied: 2.5 MPa≦σ2≦7.0 MPa.

Preferably, the center part extends to the effective surface of the screen on the face part, and the edge part is the region outside the effective surface of the screen. Alternatively, the edge part inwardly may extend approximately 20 mm from the outermost side of the face part, and the center part may be located inside the edge part.

Preferably, on the assumption that the compression stress of the skirt part around the seal edge thereof is σ3, the panel is constructed such that the following inequality is satisfied: 0.63≦σ3/σ1≦1.32.

Preferably, the compression stress of the skirt part is set such that the following inequality is satisfied: 1.0 MPa≦σ3≦3.6 MPa.

Preferably, the skirt part extends approximately 60 mm from the seal edge thereof toward the blend round part.

According to the present invention, the panel is constructed according to an optimal compression stress relation. Consequently, the present invention has the effect of satisfying the safety of the explosion-resistance characteristic and compensating for the reduction of vacuum strength, which is caused when the deflection angle of the cathode ray tube is increased and the panel is flattened.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side view, partially cut away, illustrating a conventional cathode ray tube;

FIG. 2 is a side view schematically illustrating the modification of a cathode ray tube;

FIG. 3 is a view schematically illustrating the structure of a panel of the conventional cathode ray tube;

FIG. 4 is a perspective view illustrating a panel for wide-angle flat cathode ray tubes according to the present invention;

FIG. 5 is a view schematically illustrating the structure of the panel according to the present invention; and

FIG. 6 is a rear view illustrating the panel according to the present invention.

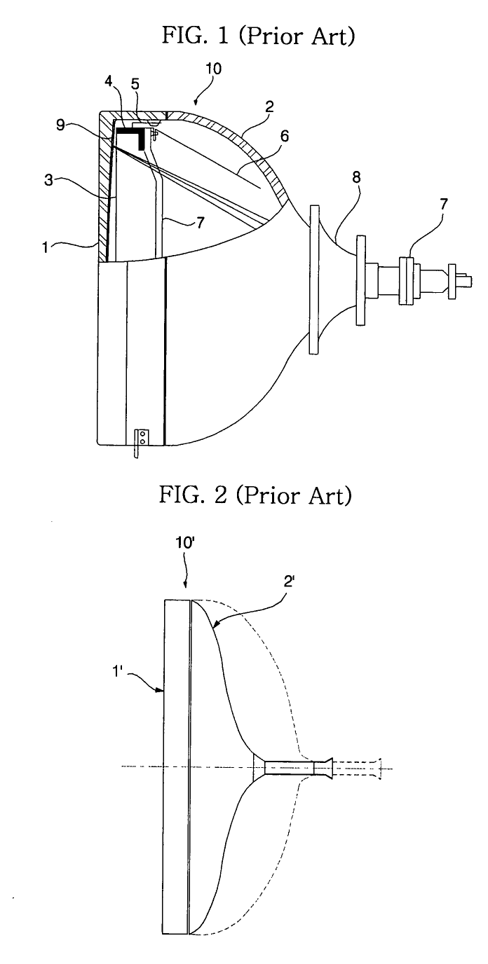

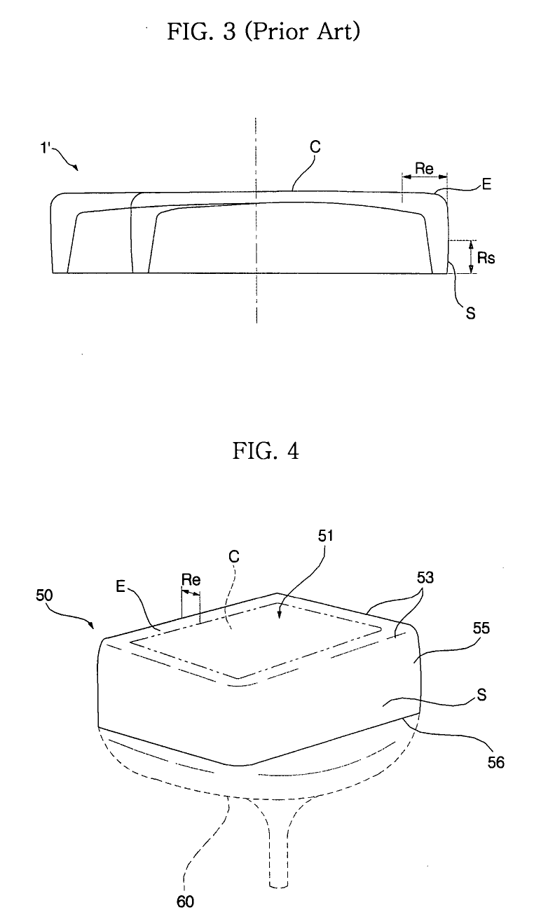

### DESCRIPTION OF THE PREFERRED EMBODIMENTS

Now, a preferred embodiment of the present invention will be described in detail with reference to the accompanying drawings.

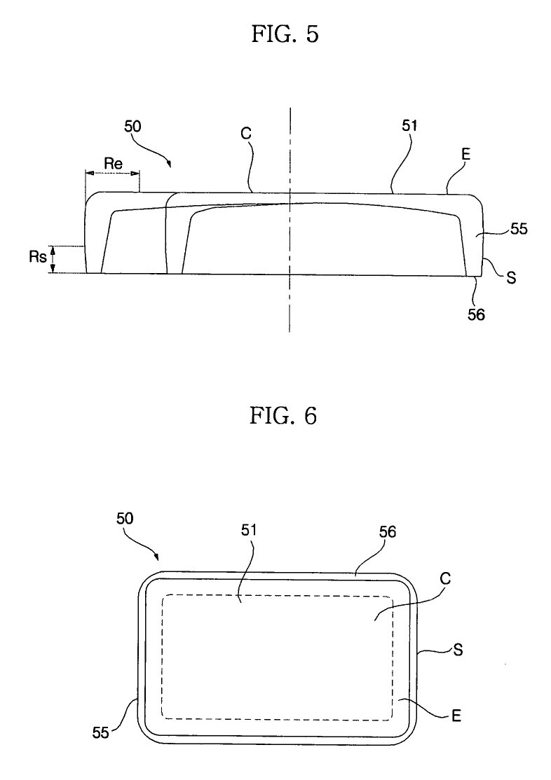

FIG. 4 is a perspective view illustrating a panel for wide-angle flat cathode ray tubes according to the present invention, FIG. 5 is a view schematically illustrating the structure of the panel according to the present invention, and FIG. 6 is a rear view illustrating the panel according to the present invention.

Preferably, the present invention is applied to a wide-angle flat cathode ray tube wherein the deflection angle is approximately 110 to 140 degrees and the overall length of a tube part, which is constituted by a panel 50 and a funnel 60, is 350 mm or less.

As shown in FIGS. 4 to 6, the panel 50 for wide-angle flat cathode ray tubes according to the present invention comprises: a face part 51 formed at the front part thereof for displaying a picture; a skirt part 55 having a seal edge 56 joined with the funnel 60; and a blend round part 53 connected between the face part 51 and the skirt part 55.

On the surfaces of the face part 51 and the blend round part 53 is formed a compression stress layer by a process to improve physical strength.

Here, it is preferable not to form the compression stress layer that is too strong on the surface of the panel 50. For this reason, it is important to design the panel 50 such that appropriate compression stress is distributed to the center region of the face part 51, the region of the blend round part 53, and the region of the skirt part 55.

Consequently, it is necessary to derive an optimal compression stress relation of the panel 50.

In the following description, the center region of the face part 51 will be referred to a center part C, the edge region of the face part 51 adjacent to the blend round part 53 will be referred to an edge part E, and the region of the skirt part 55 will be referred to as a skirt part S.

Also, the compression stress at the surface of the center part C will be indicated by σ1, the compression stress at the surface of the edge part E will be indicated by σ2, and the compression stress at the surface of the skirt part S will be indicated by σ3.

The center part C is separated from the edge part E as follows: the center part C extends to the effective surface of the screen on the face part 51, and the edge part E is the region outside the effective surface of the screen. Alternatively, the edge part E may extend a predetermined distance Re from the outermost side of the panel 50 toward the center part C of the panel 50. Preferably, the edge part E extends approximately 20 mm from the outermost side of the panel 50 toward the center part C of the panel 50.

Also, the skirt part S extends a predetermined height Rs from a seal edge 56, which is joined with the funnel 60, toward the blend round part 53. Preferably, the skirt part S extends approximately 60 mm.

Under the above-specified conditions, a missile test was performed while the compression stresses of the center part C, the edge part E, and the skirt part S were changed as indicated in Table 2 below.

TABLE 2

| Edge | Center | | Skirt | | | | | | | | | |
|---|---|---|---|---|---|---|---|---|---|---|---|---|
| (σ2) | (σ1) | σ2/σ1 | (σ3) | σ3/σ1 | Satisfaction | 7J | 9J | 10J | 11J | 12J | 13J | 14J |
| 7 | 5.5 | 1.27 | 4 | 0.73 | OK | 70% | 50% | 25% | | | | |
| | | | | | NG | 30% | 50% | 75% | | | | |
| 4.5 | 3 | 1.50 | 3.1 | 1.03 | OK | 100% | 100% | 100% | 25% | | | |
| | | | | | NG | | | | 75% | | | |
| 2.5 | 1.6 | 1.56 | 1 | 0.63 | OK | 100% | 100% | 100% | | | | |
| | | | | | NG | | | | 100% | | | |
| 5 | 2.5 | 2.00 | 3.3 | 1.32 | OK | 100% | 100% | 100% | 25% | | | |
| | | | | | NG | | | | 75% | | | |
| 7 | 3 | 2.33 | 3.6 | 1.20 | OK | 100% | 100% | 100% | 50% | | | |
| | | | | | NG | | | | 50% | | | |
| 11 | 4 | 2.75 | 4.2 | 1.05 | OK | 20% | 40% | 50% | 25% | | | |
| | | | | | NG | 80% | 60% | 50% | 75% | | | |

It can be seen from Table 2 that, when the compression stresses of the center part C, the edge part E, and the skirt part S were appropriately adjusted, the missile tests were considerably more successful when compared with the conventional art as indicated in Table 1.

Specifically, when the ratio in compression stress of the edge part E to the center part C (σ2/σ1) was 1.50 to 2.33, the missile tests were successful at 10J. When the ratio in compression stress of the edge part E to the center part C (σ2/σ1) was 1.27 or 2.75 or more, on the other hand, the explosion-resistance characteristic was lowered.

Especially when the ratio in compression stress of the edge part E to the center part C (σ2/σ1) was 2.75 or more, the explosion-resistance characteristic was significantly lowered.

Consequently, the panel 50 according to the present invention is constructed such that the ratio in compression stress of the edge part E to the center part C (σ2/σ1) satisfies the following inequality: 1.5≦σ2/σ1<2.33.

Preferably, the panel 50 according to the present invention is constructed such that the ratio in compression stress of the skirt part S to the center part C (σ3/σ1) satisfies the following inequality: 0.63≦σ3/σ1≦1.32.

Also preferably, the compression stress of the center part C is set such that the following inequality is satisfied: 1.6 MPa≦σ1≦3 MPa, the compression stress of the edge part E is set such that the following inequality is satisfied: 2.5 MPa≦σ2≦7.0 MPa, and the compression stress of the skirt part S is set such that the following inequality is satisfied: 1.0 MPa≦σ3≦3.6 MPa.

As described above, the compression stresses of the center part C, the edge part E, and the skirt part S of the panel 50 are appropriately adjusted to derive an optimal compression stress relation, thereby compensating for the reduction of vacuum strength, which is caused when the deflection angle of the cathode ray tube is increased and the panel 50 is flattened, and satisfying the safety of the explosion-resistance characteristic.

As the compression stress of the panel 50 is appropriately set as described above, the cathode ray tube cracks without generation of sparks when the panel 50 is struck during the missile test. As a result, the vacuum in the cathode ray tube is destroyed. Consequently, the glass strength of the compression stress layer of the panel is increased while the UL rules are satisfied, and therefore, the explosion-resistance characteristic is improved.

As apparent from the above description, the panel is constructed according to an optimal compression stress relation. Consequently, the present invention has the effect of satisfying the safety of the explosion-resistance characteristic and compensating for the reduction of vacuum strength, which is caused when the deflection angle of the cathode ray tube is increased and the panel is flattened.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A panel for wide-angle flat cathode ray tubes, comprising:
a face part formed at the front part thereof for displaying a picture;
a skirt part having a seal edge joined with the funnel; and
a blend round part connected between the face part and the skirt part, wherein
on the assumption that the compression stress of a center part, which is the center region of the face part, is σ1, and the compression stress of an edge part, which is the edge region of the face part adjacent to the blend round part, is σ2,
the panel is constructed such that the following inequality is satisfied: 1.5≦σ2/σ1≦2.33.

2. The panel as set forth in claim 1, wherein the compression stress of the center part is set such that the following inequality is satisfied: 1.6 MPa≦1≦3 MPa.

3. The panel as set forth in claim 1, wherein the compression stress of the edge part is set such that the following inequality is satisfied: 2.5 MPa≦σ2≦7.0 MPa.

4. The panel as set forth in claim 1, wherein the center part extends to the effective surface of the screen on the face part, and the edge part is the region outside the effective surface of the screen.

5. The panel as set forth in claim 1, wherein the edge part inwardly extends approximately 20 mm from the outermost side of the face part, and the center part is located inside the edge part.

6. The panel as set forth in claim 1, wherein
on the assumption that the compression stress of the skirt part around the seal edge thereof is σ3,
the panel is constructed such that the following inequality is satisfied: 0.63≦σ3/σ1≦1.32.

7. The panel as set forth in claim 6, wherein the compression stress of the skirt part is set such that the following inequality is satisfied: 1.0 MPa≦σ3≦3.6 MPa.

8. The panel as set forth in claim 7, wherein
the compression stress of the center part is set such that the following inequality is satisfied: 1.6 MPa≦σ1≦3 MPa, and
the compression stress of the edge part is set such that the following inequality is satisfied: 2.5 MPa≦σ2≦7.0 MPa.

9. The panel as set forth in claim 6, wherein the skirt part extends approximately 60 mm from the seal edge thereof toward the blend round part.

10. The panel as set forth in claim 1, wherein
the compression stress of the center part is set such that the following inequality is satisfied: 1.6 MPa≦σ1≦3 MPa, and
the compression stress of the edge part is set such that the following inequality is satisfied: 2.5 MPa≦σ2≦7.0 MPa.

11. The panel as set forth in claim 10, wherein the center part extends to the effective surface of the screen on the face part, and the edge part is the region outside the effective surface of the screen.

12. The panel as set forth in claim 10, wherein the edge part inwardly extends approximately 20 mm from the outermost side of the face part, and the center part is located inside the edge part.

13. The panel as set forth in claim 10, wherein
on the assumption that the compression stress of the skirt part around the seal edge thereof is σ3,
the panel is constructed such that the following inequality is satisfied: 0.63≦σ3σ1≦1.32.

14. A panel for wide-angle flat cathode ray tubes, comprising:
a face part formed at the front part thereof for displaying a picture;
a skirt part having a seal edge joined with the funnel; and
a blend round part connected between the face part and the skirt part, wherein
on the assumption that the compression stress of a center part, which is the center region of the face part, is σ1, the compression stress of an edge part, which is the edge region of the face part adjacent to the blend round part, is σ2, and the compression stress of the skirt part around the seal edge thereof is σ3,
the panel is constructed such that the following inequality is satisfied: 1.5≦σ2/σ1≦2.33 and 0.63≦σ3/σ1≦1.32,
the compression stress of the center part is set such that the following inequality is satisfied: 1.6 MPa≦σ1≦3 MPa,
the compression stress of the edge part is set such that the following inequality is satisfied: 2.5 MPa≦σ2σ≦7.0 MPa, and
the compression stress of the skirt part is set such that the following inequality is satisfied: 1.0 MPa≦σ3≦3.6 MPa.

15. The panel as set forth in claim 14, wherein the center part extends to the effective surface of the screen on the face part, and the edge part is the region outside the effective surface of the screen.

16. The panel as set forth in claim 14, wherein the edge part inwardly extends approximately 20 mm from the outermost side of the face part, and the center part is located inside the edge part.

17. The panel as set forth in claim 14, wherein the skirt part extends approximately 60 mm from the seal edge thereof toward the blend round part.
